(19) United States
(12) Patent Application Publication
(10) Pub. No.: US 2025/0004206 A1
(43) Pub. Date: Jan. 2, 2025

(54) STACKED PACKAGE DESIGN FOR MORE RELIABLE FIBER COUPLING TO PHOTONIC INTEGRATED CIRCUIT

(71) Applicant: Intel Corporation, Santa Clara, CA (US)

(72) Inventors: Chia-Pin Chiu, Tempe, AZ (US); Tim T. Hoang, San Jose, CA (US); Kaveh Hosseini, Livermore, CA (US); Omkar G. Karhade, Chandler, AZ (US)

(73) Assignee: Intel Corporation, Santa Clara, CA (US)

(21) Appl. No.: 18/343,175

(22) Filed: Jun. 28, 2023

(51) Int. Cl. G02B 6/30; G02B 6/42

(52) U.S. Cl. CPC G02B 6/30; G02B 6/4239; G02B 6/4249; G02B 6/4281

(57) ABSTRACT

In one embodiment, an integrated circuit package includes a first (top) package substrate, a photonics integrated circuit (PIC) die coupled to the first package substrate, and a second package substrate coupled to a bottom side of the first package substrate. The package further includes a pedestal coupled to a top side of the second package substrate in an area of the second package substrate that extends beyond an edge of the first package substrate at which the PIC die is located.

### GOVERNMENT INTEREST STATEMENT

This invention was made with Government support under Agreement No. HR00111830002 awarded by the United States Department of Defense. The Government has certain rights in the invention.

### BACKGROUND

Photonic integrated circuits (PIC) rely on die-edge coupling to couple waveguides of the PIC to external optical fibers, e.g., those in fiber array units (FAUs). The optical fibers may be bonded to the die edge of the PIC by optical epoxy in many cases. However, the bonding area between the fiber and the die edge of the PIC is very small, and the bonding force may not be strong and/or reliable enough to support the optical fiber under stress or strain that can be experienced in real world implementations. Thus, without external hardware, optical fiber connections may be very insecure.

### BRIEF DESCRIPTION OF THE DRAWINGS

FIG. 1 illustrates an example stacked integrated circuit package in accordance with certain embodiments.

FIG. 2 illustrates another example stacked integrated circuit package in accordance with certain embodiments.

FIG. 3 illustrates yet another example stacked integrated circuit package in accordance with certain embodiments.

FIG. 4 is a top view of a wafer and dies that may be included in any of the embodiments disclosed herein.

FIG. 5 is a cross-sectional side view of an integrated circuit device assembly that may include embodiments disclosed herein.

FIG. 6 is a cross-sectional side view of an integrated circuit device that may be included in any of the embodiments disclosed herein.

FIG. 7 is a block diagram of an example electrical device that may include any of the embodiments disclosed herein.

### DETAILED DESCRIPTION

Embodiments herein provide a stacked package design for more reliable fiber coupling to photonic integrated circuit (PIC) chips of the package. In typical package designs, the package only includes a single package substrate. Current techniques for addressing the insecure nature of fiber connections to PICS include providing a support structure between the bottom of the fiber and the side of the package substrate, where the PIC edge is aligned with the edge of the package substrate. However, this may provide relatively little support to the fiber as the substrate thickness and the size of the supporting structure are both small. Further, the weight of the supporting structure can affect the bonding between the fiber and the PIC, since the additional weight can pull downward on the fiber, stressing the epoxy bond between the fiber and the PIC. In some cases, a different, mechanical epoxy may be used to bond the support structure to the edge of the package substrate than the optical epoxy used to bond the fiber and the PIC, and the proximity of the support structure (and thus, the mechanical epoxy) can cause one or both of the epoxies to spill over and contaminate the other.

Other techniques include providing a small cavity in a top area the package substrate near the PIC and using the remaining package substrate portion below the cavity to support the fiber. However, implementation of these small cavities within the top area of the package substrate can be expensive and complicated. Further, there is limited vertical area allowed by such cavities, allowing for less vertical adjustability when attaching fiber to the PIC.

In embodiments herein, a stacked package design is implemented to provide better support for attached fiber. The stacked package design includes a first (top) package substrate to which integrated circuit dies may be coupled, as in traditional integrated circuit package designs, as well as a second (bottom) package substrate below the top package substrate. The bottom package substrate includes an additional area that extends beyond the edge of the top package substrate at which the PICs are located, and the additional area of the bottom package substrate below the area at which optical fiber attaches to the PIC includes one or more mechanisms for supporting the attached fiber (e.g., fiber array units (FAUs)).

This type of design can provide better support to the attached fiber while also reducing production and implementations costs as well. For instance, the bottom package substrate can be designed with a small number of layers and/or with just vias to connect the top package substrate to the main circuit board, allowing for reduced production costs. Moreover, the two substrate design can allow for increased rigidity for supporting attached fiber, and can provide increased vertical adjustability for the fiber attachment that previous techniques have not allowed for.

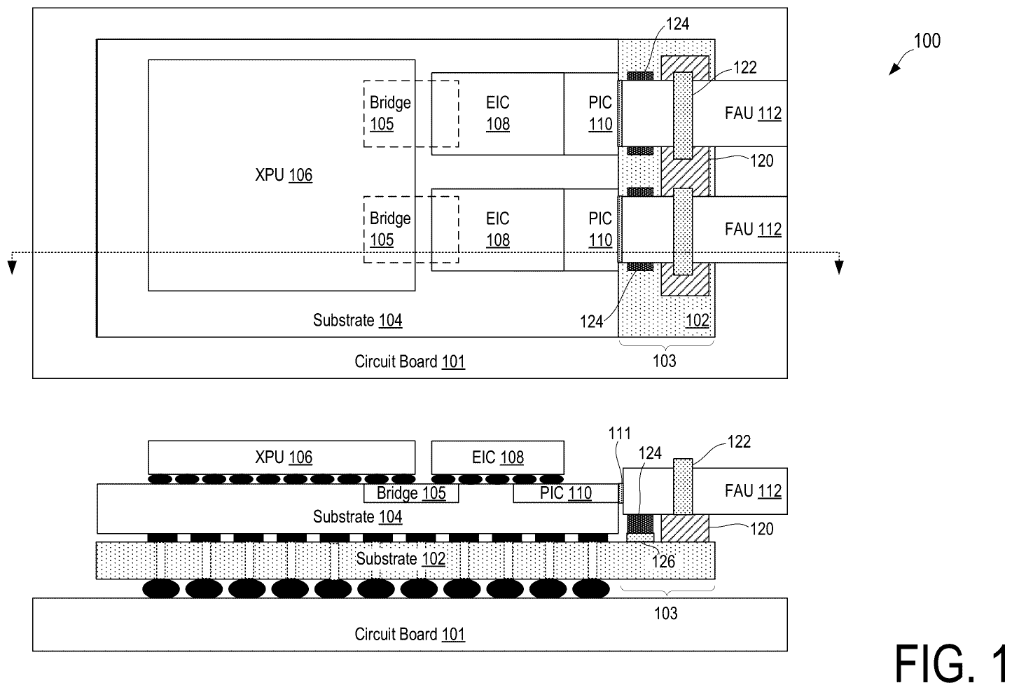

FIG. 1 illustrates an example stacked integrated circuit package 100 in accordance with certain embodiments. The example package 100 includes a main circuit board 100 with stacked package substrates 102, 104 thereon, with a top package substrate 104 being on top of a second (bottom) package substrate 102, which is coupled to the circuit board 101. The top package substrate 104 has integrated circuit dies coupled to it, which, in the example shown, includes a processor 106 and electronic integrated circuit (EIC) dies 108 coupled to the top of the substrate 104, and photonic integrated circuit (PIC) dies 110 located at an outer edge of the package substrate 104. In the example shown, the PIC dies 110 are embedded within the top surface of the substrate 104 (which may be referred to as an “open cavity PIC” in certain instances). The XPU 106 and EICs 108 are interconnected via bridge circuitries 105, and pairs of EICs 108 and PICs 110 are directly connected to one another as shown. In certain embodiments, the PICs 110 may have a thickness of approximately 50-200 μm and the FAUs 112 may have a thickness of approximately 1-2 mm.

The bottom package substrate 102 includes circuitry to interconnect the top package substrate 104 and the circuit board 101. In some embodiments, the bottom package substrate 102 may be implemented with a minimal number of layers or components to reduce costs. For example, the substrate 102 may be implemented as an interposer with vias/pillars that directly connect pads of the top substrate 104 to pads of the circuit board 101, e.g., as shown. In other embodiments, the bottom substrate 102 may include more complicated interconnect circuitries than just vias/pillars, e.g., may include redistribution layers, and/or may have other integrated circuit dies (not shown) coupled thereto. For example, the substrate 102 may be implemented as a Package on Interposer architecture that includes multiple routing layers and/or fan-out routing of traces.

As shown, the bottom package substrate 102 includes an additional area 103 that extends beyond the edge of the top package substrate 104 at whierrch the PICs 110 are located (on the right of FIG. 1). The additional area 103 has support mechanisms for mechanically supporting the fiber array units (FAUs) 112 coupled to the PICs 110 (which are coupled together via optical epoxy 111 as shown). The example support mechanisms shown include a first pedestal 120 coupled to the top of the bottom substrate 102 that extends across both FAUs 112 to support each FAU as shown, with a respective epoxy 122 laid across the top of each FAU 112 to couple each to the first pedestal 120. The support mechanisms also include a second pedestal 124 that is coupled to the substrate 102 via a mechanical epoxy 126. In contrast to the first pedestal 120, there is a second pedestal 124 for each respective FAU 112, and the second pedestal 124 for each FAU 112 is not adhesively coupled to the FAU 112 (e.g., by epoxy) like the first pedestal 120, which is adhesively coupled to each FAU 112 by the epoxy 122.

The first and second pedestals may be formed using any suitable material. In some embodiments, this may include a material with a high temperature tolerance, e.g., glass, plastics, or metals that can tolerate temperatures of approximately 250° C. (which may be seen, e.g., during a solder reflow process), and thus, can better tolerate manufacturing processes such as substrate and/or die attachment processes. In some embodiments, the first and second pedestal may be formed from different materials. For example, the first pedestal 120 may be formed from a material with a higher force tolerance than the second pedestals 124, since the forces experienced by the FAUs 112 at the first pedestal location (i.e., further away from the attachment point with the PICs 110) may be higher than at the second pedestal location.

Although two types of pedestals are shown in FIG. 1, embodiments herein may implement only one of the pedestals shown. For example, an embodiment may only include a single pedestal implemented similar to the pedestal 120 with overlaid epoxy 122, while another embodiment may include a single pedestal implemented similar to the pedestal 124 with no adhesive coupling to the FAUs 112. Moreover, aspects of each support mechanism shown may be combined with one another, or may be implemented in other ways than shown. For example, in some embodiments, a pedestal implemented similar to the second pedestal 124 may be adhesively coupled to the FAUs 112 using an epoxy in a similar manner as the first pedestal 120 is coupled to the FAUs using the epoxy 122, or a pedestal implemented similar to the first pedestal 120 may be implemented without the epoxy overlaid across the FAUs 112.

The support mechanisms shown may be attached to or formed on the bottom substrate 102 at any suitable time during the manufacturing process. In some embodiments, the support mechanisms may be attached to/formed on the bottom substrate 102 prior to the top substrate 104 being attached to the bottom substrate (which may be prior to both being attached to the circuit board 101). In other embodiments, the support mechanisms may be attached to/formed on the bottom substrate 102 after the top substrate 104 has been attached, but prior to the FAUs 112 being connected to the PICs 110.

The package substrates 102, 104 may include circuitry to connect the integrated circuit dies of the package (e.g., 106, 108, 110) to the main circuit board 101 (which may be, e.g., a motherboard or main board of a computing system) and/or to interconnect the dies with one another. For example, the package substrates 102, 104 may include connections for signaling between the main circuit board 101 and the integrated circuit dies of the package, as well as connections for providing power delivery from the main circuit board 101 (e.g., from a power supply coupled to the main circuit board) to the dies.

The bridge circuitries 105 may be implemented, in certain instances, as dies embedded within the package substrate 104. However, other embodiments may implement the bridge circuitries 105 as circuitry within upper layers of the package substrate 104. The bridge circuitries 105 may include any suitable passive and/or active circuitry to interconnect the XPU 106 with the EIC 108. An example implementation of the bridge circuitries 105 is an Intel® Embedded Multi-Die Interconnect Bridge (EMIB) die.

The XPU 106 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units.

The PICs 110 may include circuitry to receive optical signals from a source (e.g., attached fiber), convert the optical signals to electrical signals, and provide the electrical signals to other circuitry (e.g., to the EIC and/or the XPU). Likewise, the PICs may include circuitry to receive electrical signals (e.g., from the EIC and/or the XPU), generate optical signals based on the electrical signals, and provide the optical signals to the fiber. The PICs may include one or more lasers or other light sources, detectors, amplitude and/or phase modulators, filters, splitters, amplifiers, interferometers, micro ring resonators (MRR), gratings, squeezed or other quantum light sources, etc. The PIC circuitry may perform other functions beyond converting optical signals to electrical signals or vice versa, e.g., matrix multiplication, quantum logic gates, optical compute gates, etc. The EICs 108 may include circuitry to control and/or drive the circuitry within the PIC coupled thereto, and/or other electrical circuitry for processing the signals from the PIC. For instance, the EICs may include components such as, for example, transimpedance amplifiers (TIA), serializer/deserializer (SERDES) circuits, driver circuits, etc. The optical signals may be received from an array of fiber, e.g., FAUs 112, which may be implemented as a fiber pigtail connection, that is coupled to the PIC, e.g., via optical epoxy 111 as shown.

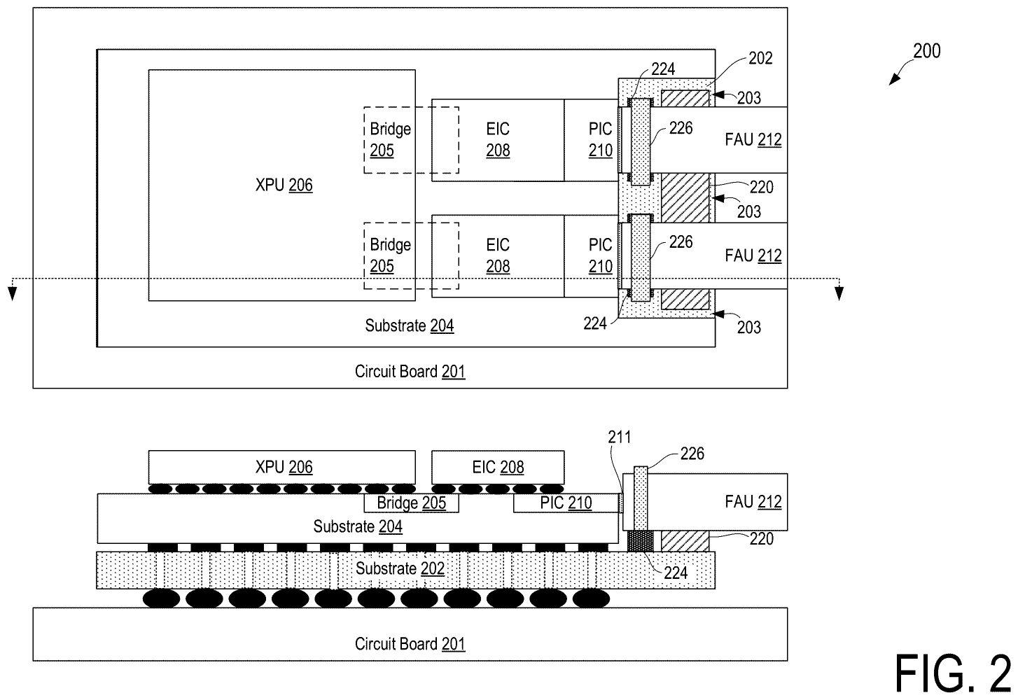

FIG. 2 illustrates another example stacked integrated circuit package 200 in accordance with certain embodiments. The example package 200 is implemented in the same manner as the package 100 of FIG. 1, but with different support mechanisms. That is, the circuit board 201 is implemented in the same manner as the circuit board 101, the substrate 202 is implemented in the same manner as the substrate 102, the substrate 204 is implemented in a similar manner as the substrate 104 (albeit with a different form as described below), the bridge circuitries 205 are implemented in the same manner as the bridge circuitries 105, the XPU 206 is implemented in the same manner as the XPU 106, the EICs 208 are implemented in the same manner as the EICs 108, the PICs 210 are implemented in the same manner as the PICs 110, and the FAUs 212 are implemented in the same manner as the FAUs 112.

However, in the example shown, the substrate 202 is implemented generally with the same dimensions as the substrate 204, but the substrate 204 includes a cutout region 203 as shown, in which the fiber support mechanisms of the package 200 are located. The support mechanisms of the package 200 include a first pedestal 220 and second pedestals 224 similar to the package 100. However, the first pedestal 220 is not adhesively coupled to the FAUs 212 as in the example shown in FIG. 1, while the second pedestals 224 are adhesively coupled to the FAUs 212 using an epoxy 226 as shown. The pedestals 220, 224 may be implemented using the same types of materials or in the same manner as described above with respect to pedestals 120, 124. Further, as in the example above, although two types of pedestals are shown, embodiments herein may implement only one of the pedestals shown. For example, an embodiment may only include a single pedestal implemented similar to the pedestal 220 with no adhesive coupling to the FAUs 212, while another embodiment may include a single pedestal implemented similar to the pedestal 224 with adhesive coupling to the FAUs 212. Moreover, aspects of each support mechanism shown may be combined with one another or may be implemented in other ways than shown.

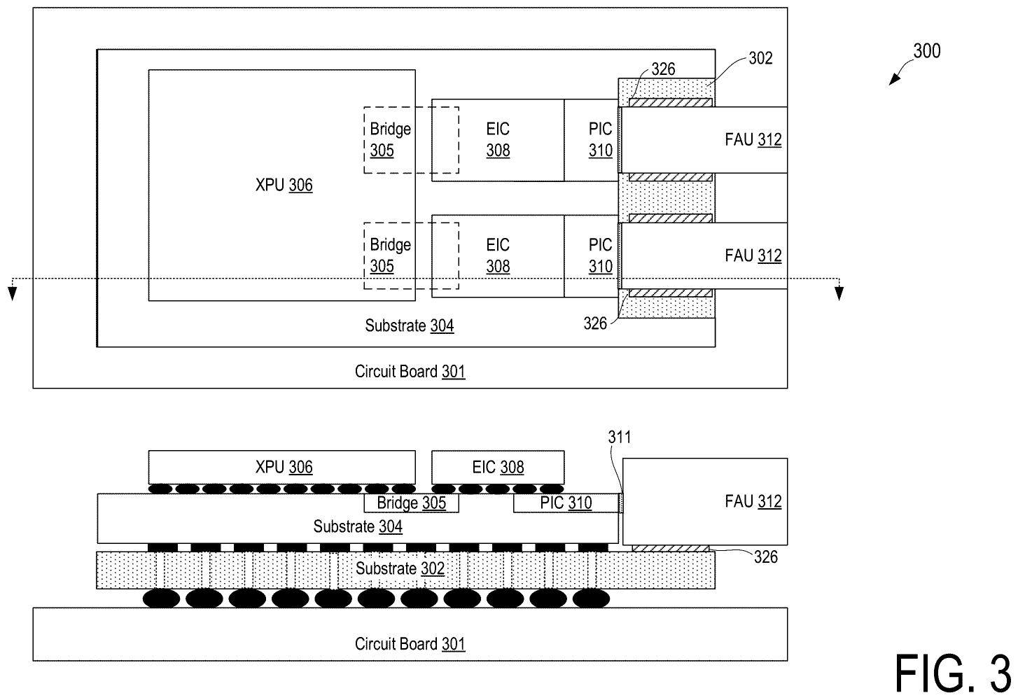

FIG. 3 illustrates another example stacked integrated circuit package 300 in accordance with certain embodiments. The example package 300 is implemented in the same manner as the packages 100, 200 described above, but does not include a pedestal for supporting the FAUs 312. Rather, the FAUs 312 are coupled directly to the substrate 302 using an epoxy 326 as shown. The circuit board 301 is implemented in the same manner as the circuit boards 101 and 201, the substrate 302 is implemented in the same manner as the substrates 102 and 202, the substrate 304 is implemented in a similar manner as the substrate 204, the bridge circuitries 305 are implemented in the same manner as the bridge circuitries 105 and 205, the XPU 306 is implemented in the same manner as the XPUs 106 and 206, the EICs 308 are implemented in the same manner as the EICs 108 and 208, the PICs 310 are implemented in the same manner as the PICs 110 and 210, and the FAUs 312 are implemented in the same manner as the FAUs 112 and 212.

Although the examples described above include two PIC dies at a single (right or “east”) edge of an upper substrate (e.g., 104, 204, 304), embodiments of the present disclosure may include any number of PIC dies and the PIC dies may be located at any edge of the upper substrate, including one or more PIC dies at each outer edge of the upper substrate. For example, some embodiments may include three PIC dies coupled (e.g., through EIC dies) to each of four different sides of an XPU (e.g., 106, 206, 306), i.e., with 12 total PIC dies coupled to respective EIC dies, which are in turn coupled to a central XPU. Moreover, although the example PIC dies in the examples above are implemented “open cavity” designs, embodiments of the present disclosure may include PIC dies that are coupled to the upper substrate in another manner. Finally, the examples shown in each of FIGS. 1-3 may not be drawn to scale, i.e., embodiments of the present disclosure may include components having proportions that differ from those shown or differ with respect to other components shown. For example, the proportions of the example FAUs and PIC dies with respect to one another may differ from those shown in FIGS. 1-3.

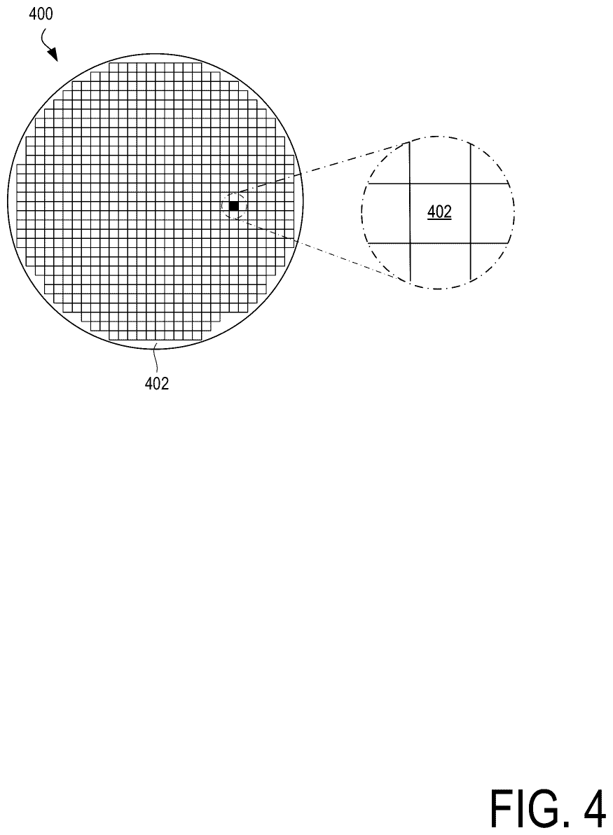

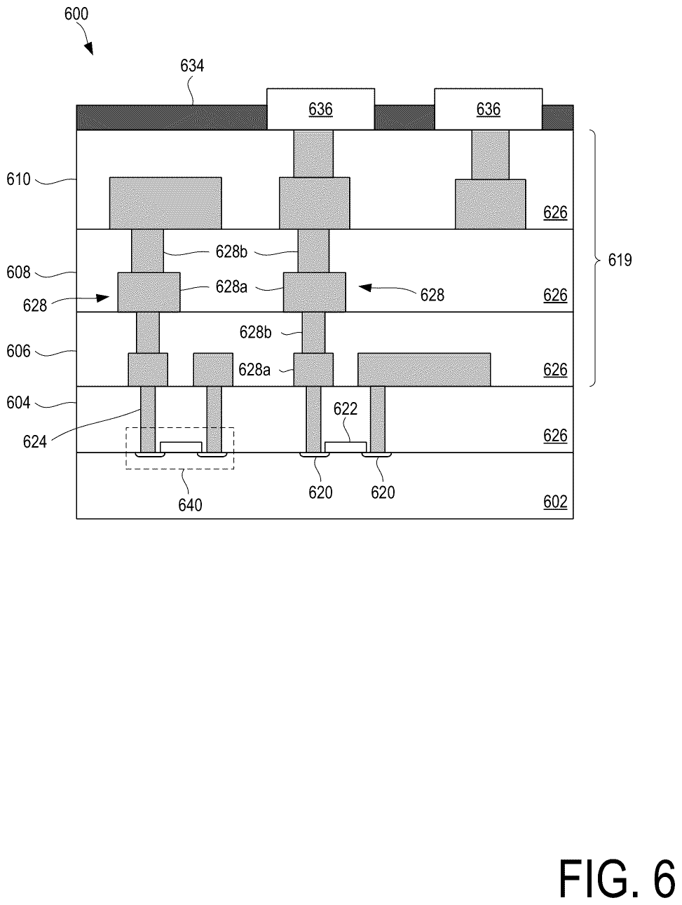

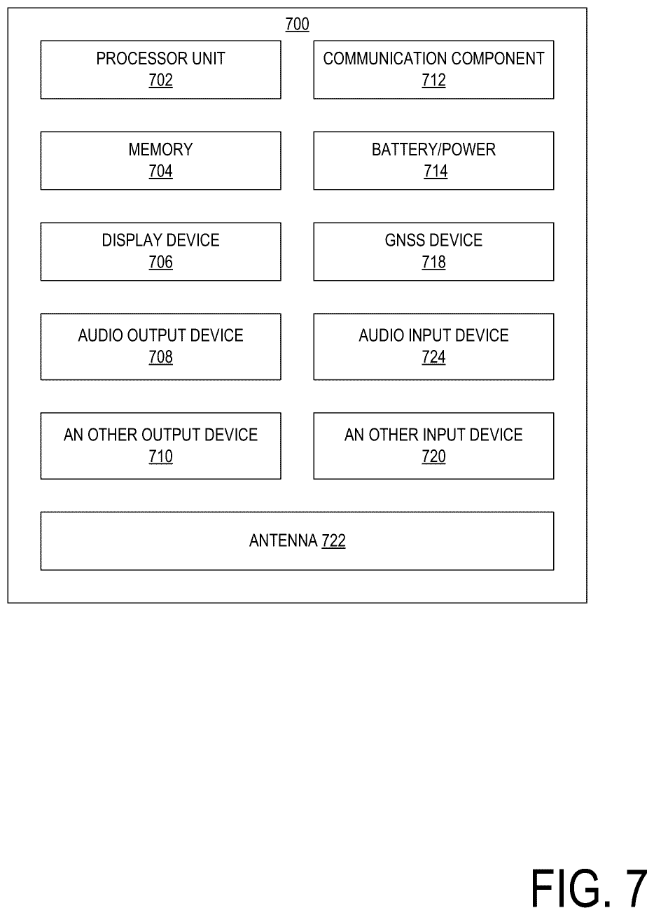

FIG. 4 is a top view of a wafer 400 and dies 402 that may be implemented in or along with any of the embodiments disclosed herein. The wafer 400 may be composed of semiconductor material and may include one or more dies 402 having integrated circuit structures formed on a surface of the wafer 400. The individual dies 402 may be a repeating unit of an integrated circuit product that includes any suitable integrated circuit. After the fabrication of the semiconductor product is complete, the wafer 400 may undergo a singulation process in which the dies 402 are separated from one another to provide discrete “chips” of the integrated circuit product. The die 402 may include one or more transistors (e.g., some of the transistors 640 of FIG. 6, discussed below), supporting circuitry to route electrical signals to the transistors, passive components (e.g., signal traces, resistors, capacitors, or inductors), and/or any other integrated circuit components. In some embodiments, the wafer 400 or the die 402 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 402. For example, a memory array formed by multiple memory devices may be formed on a same die 402 as a processor unit (e.g., the processor unit 702 of FIG. 7) or other logic that is configured to store information in the memory devices or execute instructions stored in the memory array.

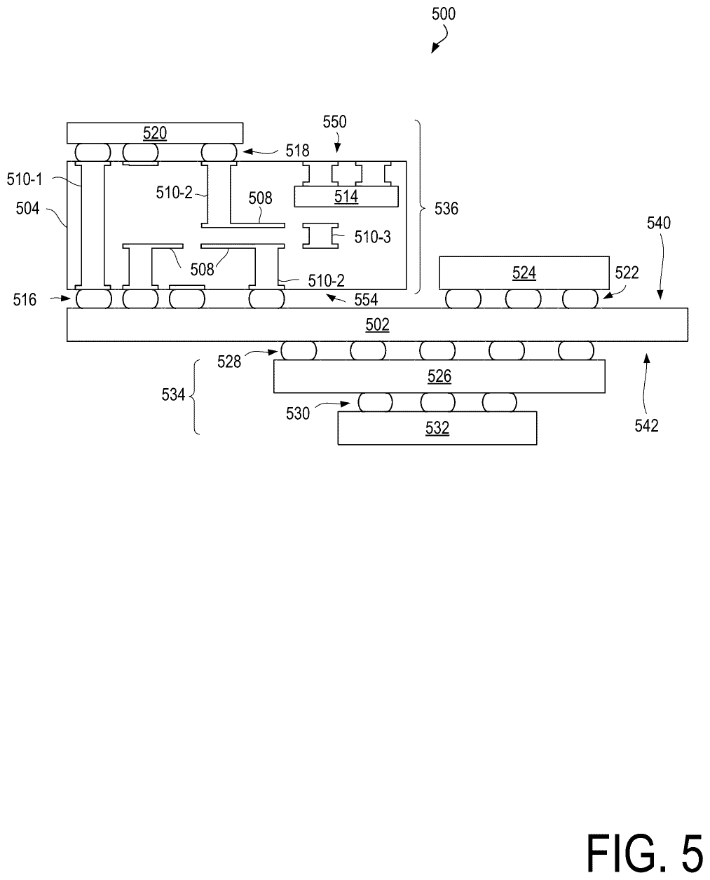

FIG. 5 is a cross-sectional side view of an integrated circuit device assembly 500 that may include any of the embodiments disclosed herein. The integrated circuit device assembly 500 includes a number of components disposed on a circuit board 502 (which may be a motherboard, system board, mainboard, etc.). The integrated circuit device assembly 500 includes components disposed on a first face 540 of the circuit board 502 and an opposing second face 542 of the circuit board 502; generally, components may be disposed on one or both faces 540 and 542.

In some embodiments, the circuit board 502 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 502. In other embodiments, the circuit board 502 may be a non-PCB substrate. The integrated circuit device assembly 500 illustrated in FIG. 5 includes a package-on-interposer structure 536 coupled to the first face 540 of the circuit board 502 by coupling components 516. The coupling components 516 may electrically and mechanically couple the package-on-interposer structure 536 to the circuit board 502, and may include solder balls (as shown in FIG. 5), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 536 may include an integrated circuit component 520 coupled to an interposer 504 by coupling components 518. The coupling components 518 may take any suitable form for the application, such as the forms discussed above with reference to the coupling components 516. Although a single integrated circuit component 520 is shown in FIG. 5, multiple integrated circuit components may be coupled to the interposer 504; indeed, additional interposers may be coupled to the interposer 504. The interposer 504 may provide an intervening substrate used to bridge the circuit board 502 and the integrated circuit component 520.

The integrated circuit component 520 may be a packaged or unpacked integrated circuit product that includes one or more integrated circuit dies (e.g., the die 402 of FIG. 4, the integrated circuit device 600 of FIG. 6) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 520, a single monolithic integrated circuit die comprises solder bumps attached to contacts on the die. The solder bumps allow the die to be directly attached to the interposer 504. The integrated circuit component 520 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 520 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 520 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 520 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 504 may spread connections to a wider pitch or reroute a connection to a different connection. For example, the interposer 504 may couple the integrated circuit component 520 to a set of ball grid array (BGA) conductive contacts of the coupling components 516 for coupling to the circuit board 502. In the embodiment illustrated in FIG. 5, the integrated circuit component 520 and the circuit board 502 are attached to opposing sides of the interposer 504; in other embodiments, the integrated circuit component 520 and the circuit board 502 may be attached to a same side of the interposer 504. In some embodiments, three or more components may be interconnected by way of the interposer 504.

In some embodiments, the interposer 504 may be formed as a PCB, including multiple metal layers separated from one another by layers of dielectric material and interconnected by electrically conductive vias. In some embodiments, the interposer 504 may be formed of an epoxy resin, a fiberglass-reinforced epoxy resin, an epoxy resin with inorganic fillers, a ceramic material, or a polymer material such as polyimide. In some embodiments, the interposer 504 may be formed of alternate rigid or flexible materials that may include the same materials described above for use in a semiconductor substrate, such as silicon, germanium, and other group III-V and group IV materials. The interposer 504 may include metal interconnects 508 and vias 510, including but not limited to through hole vias 510-1 (that extend from a first face 550 of the interposer 504 to a second face 554 of the interposer 504), blind vias 510-2 (that extend from the first or second faces 550 or 554 of the interposer 504 to an internal metal layer), and buried vias 510-3 (that connect internal metal layers).

In some embodiments, the interposer 504 can comprise a silicon interposer. Through silicon vias (TSV) extending through the silicon interposer can connect connections on a first face of a silicon interposer to an opposing second face of the silicon interposer. In some embodiments, an interposer 504 comprising a silicon interposer can further comprise one or more routing layers to route connections on a first face of the interposer 504 to an opposing second face of the interposer 504.

The interposer 504 may further include embedded devices 514, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 504. The package-on-interposer structure 536 may take the form of any of the package-on-interposer structures known in the art. In embodiments where the interposer is a non-printed circuit board

The integrated circuit device assembly 500 may include an integrated circuit component 524 coupled to the first face 540 of the circuit board 502 by coupling components 522. The coupling components 522 may take the form of any of the embodiments discussed above with reference to the coupling components 516, and the integrated circuit component 524 may take the form of any of the embodiments discussed above with reference to the integrated circuit component 520.

The integrated circuit device assembly 500 illustrated in FIG. 5 includes a package-on-package structure 534 coupled to the second face 542 of the circuit board 502 by coupling components 528. The package-on-package structure 534 may include an integrated circuit component 526 and an integrated circuit component 532 coupled together by coupling components 530 such that the integrated circuit component 526 is disposed between the circuit board 502 and the integrated circuit component 532. The coupling components 528 and 530 may take the form of any of the embodiments of the coupling components 516 discussed above, and the integrated circuit components 526 and 532 may take the form of any of the embodiments of the integrated circuit component 520 discussed above. The package-on-package structure 534 may be configured in accordance with any of the package-on-package structures known in the art.

FIG. 6 is a cross-sectional side view of an integrated circuit device 600 that may be included in any of the embodiments disclosed herein. One or more of the integrated circuit devices 600 may be included in one or more dies 402 (FIG. 4). The integrated circuit device 600 may be formed on a die substrate 602 (e.g., the wafer 400 of FIG. 4) and may be included in a die (e.g., the die 402 of FIG. 4). The die substrate 602 may be a semiconductor substrate composed of semiconductor material systems including, for example, n-type or p-type materials systems (or a combination of both). The die substrate 602 may include, for example, a crystalline substrate formed using a bulk silicon or a silicon-on-insulator (SOI) substructure. In some embodiments, the die substrate 602 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 602. Although a few examples of materials from which the die substrate 602 may be formed are described here, any material that may serve as a foundation for an integrated circuit device 600 may be used. The die substrate 602 may be part of a singulated die (e.g., the dies 402 of FIG. 4) or a wafer (e.g., the wafer 400 of FIG. 4).

The integrated circuit device 600 may include one or more device layers 604 disposed on the die substrate 602. The device layer 604 may include features of one or more transistors 640 (e.g., metal oxide semiconductor field-effect transistors (MOSFETs)) formed on the die substrate 602. The transistors 640 may include, for example, one or more source and/or drain (S/D) regions 620, a gate 622 to control current flow between the S/D regions 620, and one or more S/D contacts 624 to route electrical signals to/from the S/D regions 620. The transistors 640 may include additional features not depicted for the sake of clarity, such as device isolation regions, gate contacts, and the like. The transistors 640 are not limited to the type and configuration depicted in FIG. 6 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

Returning to FIG. 6, a transistor 640 may include a gate 622 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 640 along the source-channel-drain direction, the gate electrode may consist of a U-shaped structure that includes a bottom portion substantially parallel to the surface of the die substrate 602 and two sidewall portions that are substantially perpendicular to the top surface of the die substrate 602. In other embodiments, at least one of the metal layers that form the gate electrode may simply be a planar layer that is substantially parallel to the top surface of the die substrate 602 and does not include sidewall portions substantially perpendicular to the top surface of the die substrate 602. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 620 may be formed within the die substrate 602 adjacent to the gate 622 of individual transistors 640. The S/D regions 620 may be formed using an implantation/diffusion process or an etching/deposition process, for example. In the former process, dopants such as boron, aluminum, antimony, phosphorous, or arsenic may be ion-implanted into the die substrate 602 to form the S/D regions 620. An annealing process that activates the dopants and causes them to diffuse farther into the die substrate 602 may follow the ion-implantation process. In the latter process, the die substrate 602 may first be etched to form recesses at the locations of the S/D regions 620. An epitaxial deposition process may then be carried out to fill the recesses with material that is used to fabricate the S/D regions 620. In some implementations, the S/D regions 620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 620 may be formed using one or more alternate semiconductor materials such as germanium or a group III-V material or alloy. In further embodiments, one or more layers of metal and/or metal alloys may be used to form the S/D regions 620.

Electrical signals, such as power and/or input/output (I/O) signals, may be routed to and/or from the devices (e.g., transistors 640) of the device layer 604 through one or more interconnect layers disposed on the device layer 604 (illustrated in FIG. 6 as interconnect layers 606-610). For example, electrically conductive features of the device layer 604 (e.g., the gate 622 and the S/D contacts 624) may be electrically coupled with the interconnect structures 628 of the interconnect layers 606-610. The one or more interconnect layers 606-610 may form a metallization stack (also referred to as an “ILD stack”) 619 of the integrated circuit device 600.

The interconnect structures 628 may be arranged within the interconnect layers 606-610 to route electrical signals according to a wide variety of designs; in particular, the arrangement is not limited to the particular configuration of interconnect structures 628 depicted in FIG. 6. Although a particular number of interconnect layers 606-610 is depicted in FIG. 6, embodiments of the present disclosure include integrated circuit devices having more or fewer interconnect layers than depicted.

In some embodiments, the interconnect structures 628 may include lines 628a and/or vias 628b filled with an electrically conductive material such as a metal. The lines 628a may be arranged to route electrical signals in a direction of a plane that is substantially parallel with a surface of the die substrate 602 upon which the device layer 604 is formed. For example, the lines 628a may route electrical signals in a direction in and out of the page and/or in a direction across the page from the perspective of FIG. 6. The vias 628b may be arranged to route electrical signals in a direction of a plane that is substantially perpendicular to the surface of the die substrate 602 upon which the device layer 604 is formed. In some embodiments, the vias 628b may electrically couple lines 628a of different interconnect layers 606-610 together.

The interconnect layers 606-610 may include a dielectric material 626 disposed between the interconnect structures 628, as shown in FIG. 6. In some embodiments, dielectric material 626 disposed between the interconnect structures 628 in different ones of the interconnect layers 606-610 may have different compositions; in other embodiments, the composition of the dielectric material 626 between different interconnect layers 606-610 may be the same. The device layer 604 may include a dielectric material 626 disposed between the transistors 640 and a bottom layer of the metallization stack as well. The dielectric material 626 included in the device layer 604 may have a different composition than the dielectric material 626 included in the interconnect layers 606-610; in other embodiments, the composition of the dielectric material 626 in the device layer 604 may be the same as a dielectric material 626 included in any one of the interconnect layers 606-610.

A first interconnect layer 606 (referred to as Metal 1 or “M1”) may be formed directly on the device layer 604. In some embodiments, the first interconnect layer 606 may include lines 628a and/or vias 628b, as shown. The lines 628a of the first interconnect layer 606 may be coupled with contacts (e.g., the S/D contacts 624) of the device layer 604. The vias 628b of the first interconnect layer 606 may be coupled with the lines 628a of a second interconnect layer 608.

The second interconnect layer 608 (referred to as Metal 2 or “M2”) may be formed directly on the first interconnect layer 606. In some embodiments, the second interconnect layer 608 may include via 628b to couple the interconnect structures 628 of the second interconnect layer 608 with the lines 628a of a third interconnect layer 610. Although the lines 628a and the vias 628b are structurally delineated with a line within individual interconnect layers for the sake of clarity, the lines 628a and the vias 628b may be structurally and/or materially contiguous (e.g., simultaneously filled during a dual-damascene process) in some embodiments.

The third interconnect layer 610 (referred to as Metal 3 or “M3”) (and additional interconnect layers, as desired) may be formed in succession on the second interconnect layer 608 according to similar techniques and configurations described in connection with the second interconnect layer 608 or the first interconnect layer 606. In some embodiments, the interconnect layers that are “higher up” in the metallization stack 619 in the integrated circuit device 600 (i.e., farther away from the device layer 604) may be thicker that the interconnect layers that are lower in the metallization stack 619, with lines 628a and vias 628b in the higher interconnect layers being thicker than those in the lower interconnect layers.

The integrated circuit device 600 may include a solder resist material 634 (e.g., polyimide or similar material) and one or more conductive contacts 636 formed on the interconnect layers 606-610. In FIG. 6, the conductive contacts 636 are illustrated as taking the form of bond pads. The conductive contacts 636 may be electrically coupled with the interconnect structures 628 and configured to route the electrical signals of the transistor(s) 640 to external devices. For example, solder bonds may be formed on the one or more conductive contacts 636 to mechanically and/or electrically couple an integrated circuit die including the integrated circuit device 600 with another component (e.g., a printed circuit board or a package substrate, e.g., 112). The integrated circuit device 600 may include additional or alternate structures to route the electrical signals from the interconnect layers 606-610; for example, the conductive contacts 636 may include other analogous features (e.g., posts) that route the electrical signals to external components.

In some embodiments in which the integrated circuit device 600 is a double-sided die, the integrated circuit device 600 may include another metallization stack (not shown) on the opposite side of the device layer(s) 604. This metallization stack may include multiple interconnect layers as discussed above with reference to the interconnect layers 606-610, to provide conductive pathways (e.g., including conductive lines and vias) between the device layer(s) 604 and additional conductive contacts (not shown) on the opposite side of the integrated circuit device 600 from the conductive contacts 636.

In other embodiments in which the integrated circuit device 600 is a double-sided die, the integrated circuit device 600 may include one or more through silicon vias (TSVs) through the die substrate 602; these TSVs may make contact with the device layer(s) 604, and may provide conductive pathways between the device layer(s) 604 and additional conductive contacts (not shown) on the opposite side of the integrated circuit device 600 from the conductive contacts 636. In some embodiments, TSVs extending through the substrate can be used for routing power and ground signals from conductive contacts on the opposite side of the integrated circuit device 600 from the conductive contacts 636 to the transistors 640 and any other components integrated into the integrated circuit device 600, and the metallization stack 619 can be used to route I/O signals from the conductive contacts 636 to transistors 640 and any other components integrated into the integrated circuit device 600.

Multiple integrated circuit devices 600 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

FIG. 7 is a block diagram of an example electrical device 700 that may include one or more of the embodiments disclosed herein. For example, any suitable ones of the components of the electrical device 700 may include one or more of integrated circuit devices 600, or integrated circuit dies 402 disclosed herein. A number of components are illustrated in FIG. 7 as included in the electrical device 700, but any one or more of these components may be omitted or duplicated, as suitable for the application. In some embodiments, some or all of the components included in the electrical device 700 may be attached to one or more motherboards mainboards, or system boards. In some embodiments, one or more of these components are fabricated onto a single system-on-a-chip (SoC) die.

Additionally, in various embodiments, the electrical device 700 may not include one or more of the components illustrated in FIG. 7, but the electrical device 700 may include interface circuitry for coupling to the one or more components. For example, the electrical device 700 may not include a display device 706, but may include display device interface circuitry (e.g., a connector and driver circuitry) to which a display device 706 may be coupled. In another set of examples, the electrical device 700 may not include an audio input device 724 or an audio output device 708, but may include audio input or output device interface circuitry (e.g., connectors and supporting circuitry) to which an audio input device 724 or audio output device 708 may be coupled.

The electrical device 700 may include one or more processor units 702 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 702 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 700 may include a memory 704, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 704 may include memory that is located on the same integrated circuit die as the processor unit 702. This memory may be used as cache memory (e.g., Level 1 (L1), Level 2 (L2), Level 3 (L3), Level 4 (LA), Last Level Cache (LLC)) and may include embedded dynamic random access memory (eDRAM) or spin transfer torque magnetic random access memory (STT-MRAM).

In some embodiments, the electrical device 700 can comprise one or more processor units 702 that are heterogeneous or asymmetric to another processor unit 702 in the electrical device 700. There can be a variety of differences between the processing units 702 in a system in terms of a spectrum of metrics of merit including architectural, microarchitectural, thermal, power consumption characteristics, and the like. These differences can effectively manifest themselves as asymmetry and heterogeneity among the processor units 702 in the electrical device 700.

In some embodiments, the electrical device 700 may include a communication component 712 (e.g., one or more communication components). For example, the communication component 712 can manage wireless communications for the transfer of data to and from the electrical device 700. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 712 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 712 may operate in accordance with other wireless protocols in other embodiments. The electrical device 700 may include an antenna 722 to facilitate wireless communications and/or to receive other wireless communications (such as AM or FM radio transmissions).

In some embodiments, the communication component 712 may manage wired communications, such as electrical, optical, or any other suitable communication protocols (e.g., IEEE 802.3 Ethernet standards). As noted above, the communication component 712 may include multiple communication components. For instance, a first communication component 712 may be dedicated to shorter-range wireless communications such as Wi-Fi or Bluetooth, and a second communication component 712 may be dedicated to longer-range wireless communications such as global positioning system (GPS), EDGE, GPRS, CDMA, WiMAX, LTE, EV-DO, or others. In some embodiments, a first communication component 712 may be dedicated to wireless communications, and a second communication component 712 may be dedicated to wired communications.

The electrical device 700 may include battery/power circuitry 714. The battery/power circuitry 714 may include one or more energy storage devices (e.g., batteries or capacitors) and/or circuitry for coupling components of the electrical device 700 to an energy source separate from the electrical device 700 (e.g., AC line power).

The electrical device 700 may include a display device 706 (or corresponding interface circuitry, as discussed above). The display device 706 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 700 may include an audio output device 708 (or corresponding interface circuitry, as discussed above). The audio output device 708 may include any embedded or wired or wirelessly connected external device that generates an audible indicator, such speakers, headsets, or earbuds.

The electrical device 700 may include an audio input device 724 (or corresponding interface circuitry, as discussed above). The audio input device 724 may include any embedded or wired or wirelessly connected device that generates a signal representative of a sound, such as microphones, microphone arrays, or digital instruments (e.g., instruments having a musical instrument digital interface (MIDI) output). The electrical device 700 may include a Global Navigation Satellite System (GNSS) device 718 (or corresponding interface circuitry, as discussed above), such as a Global Positioning System (GPS) device. The GNSS device 718 may be in communication with a satellite-based system and may determine a geolocation of the electrical device 700 based on information received from one or more GNSS satellites, as known in the art.

The electrical device 700 may include another output device 710 (or corresponding interface circuitry, as discussed above). Examples of the other output device 710 may include an audio codec, a video codec, a printer, a wired or wireless transmitter for providing information to other devices, or an additional storage device.

The electrical device 700 may include another input device 720 (or corresponding interface circuitry, as discussed above). Examples of the other input device 720 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 700 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 700 may be any other electronic device that processes data. In some embodiments, the electrical device 700 may comprise multiple discrete physical components. Given the range of devices that the electrical device 700 can be manifested as in various embodiments, in some embodiments, the electrical device 700 can be referred to as a computing device or a computing system.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 is an integrated circuit package comprising: a first package substrate; a photonics integrated circuit (PIC) die coupled to the first package substrate at an edge of the first package substrate; a second package substrate coupled to a bottom side of the first package substrate; and a pedestal coupled to a top side of the second package substrate in an area of the second package substrate that extends beyond the edge of the first package substrate at which the PIC die is located.

Example 2 includes the subject matter of Example 1, wherein the pedestal is a first pedestal, and the integrated circuit package further comprises a second pedestal coupled to the top side of the second package substrate in an area of the second package substrate that extends beyond the edge of the first package substrate at which the PIC die is located.

Example 3 includes the subject matter of Example 2, wherein the first pedestal and second pedestal comprise different materials.

Example 4 includes the subject matter of any one of Examples 1-3, wherein the pedestal comprises glass or metal.

Example 5 includes the subject matter of any one of Examples 1-4, wherein the first package substrate comprises a cutout region and the PIC die is located at an edge defining cutout region.

Example 6 includes the subject matter of any one of Examples 1-5, wherein the PIC die is within a cavity in a top side of the first package substrate.

Example 7 includes the subject matter of any one of Examples 1-6, further comprising an electronic integrated circuit (EIC) die coupled to the first package substrate and connected to the PIC die.

Example 8 includes the subject matter of any one of Examples 1-7, further comprising a processor coupled to the first package substrate and connected to the EIC die.

Example 9 includes the subject matter of any one of Examples 1-8, wherein the second package substrate comprises vias connected between electrical connection pads on a top side of the second package substrate and electrical connection pads on a bottom side of the second package substrate.

Example 10 includes the subject matter of any one of Examples 1-9, wherein the second package substrate comprises one or more of redistribution layer traces and fan-out traces.

Example 11 is a system comprising: an integrated circuit package comprising: a first package substrate; a photonics integrated circuit (PIC) die coupled to the first package substrate at an edge of the first package substrate; a second package substrate coupled to a bottom side of the first package substrate; and a pedestal coupled to a top side of the second package substrate in an area of the second package substrate that extends beyond the edge of the first package substrate at which the PIC die is located; and optical fiber coupled to the PIC and on a top surface of the pedestal.

Example 12 includes the subject matter of Example 11, wherein the optical fiber is adhesively coupled to the pedestal.

Example 13 includes the subject matter of Example 11 or 12, wherein the pedestal is a first pedestal, and the system further comprises a second pedestal coupled to the top side of the second package substrate in an area of the second package substrate that extends beyond the edge of the first package substrate at which the PIC die is located, and wherein the optical fiber is further on a top surface of the second pedestal.

Example 14 includes the subject matter of Example 13, wherein the first pedestal and second pedestal comprise different materials.

Example 15 includes the subject matter of any one of Examples 11-14, wherein the pedestal comprises glass or metal.

Example 16 includes the subject matter of any one of Examples 11-15, wherein the first package substrate comprises a cutout region and the PIC die is located at an edge defining cutout region.

Example 17 includes the subject matter of any one of Examples 11-16, wherein the PIC die is within a cavity in a top side of the first package substrate.

Example 18 includes the subject matter of any one of Examples 11-17, further comprising an electronic integrated circuit (EIC) die coupled to the first package substrate and connected to the PIC die.

Example 19 includes the subject matter of any one of Examples 11-18, further comprising a processor coupled to the first package substrate and connected to the EIC die.

Example 20 includes the subject matter of any one of Examples 11-19, wherein the second package substrate comprises vias connected between electrical connection pads on a top side of the second package substrate and electrical connection pads on a bottom side of the second package substrate.

Example 21 includes the subject matter of any one of Examples 11-20, wherein the second package substrate comprises one or more of redistribution layer traces and fan-out traces.

Example 22 includes the subject matter of any one of Examples 11-21, further comprising a circuit board, wherein the second package is coupled to a top side of the circuit board.

Example 23 is a system comprising: a circuit board; an integrated circuit package coupled to the circuit board, the integrated circuit package comprising: a first package substrate; a first photonics integrated circuit (PIC) die coupled to the first package substrate at an edge of the first package substrate; a first electronic integrated circuit (EIC) die coupled to the first package substrate and connected to the PIC die; a second PIC die coupled to the first package substrate at the edge of the first package substrate; a second EIC die coupled to the first package substrate and connected to the PIC die; a processor coupled to the first EIC die and the second EIC die; a second package substrate coupled to a top side of the circuit board and to a bottom side of the first package substrate; and a pedestal coupled to a top side of the second package substrate in an area of the second package substrate that extends beyond the edge of the first package substrate at which the first PIC die and second PIC die are located; a first fiber array unit (FAU) coupled to the first PIC and on a top surface of the pedestal; and a second FAU coupled to the second PIC and on the top surface of the pedestal.

Example 24 includes the subject matter of Example 23, wherein the pedestal is a first pedestal, the system further comprises a second pedestal coupled to the top side of the second package substrate in an area of the second package substrate that extends beyond the edge of the first package substrate at which the first PIC die and second PIC die are located, and wherein one of the first FAU or the second FAU are on a top surface of the second pedestal.

Example 25 includes the subject matter of Example 24, wherein the first pedestal and second pedestal comprise different materials.

Example 26 includes the subject matter of Example 24, further comprising a third pedestal coupled to the top side of the second package substrate in an area of the second package substrate that extends beyond the edge of the first package substrate at which the first PIC die and second PIC die are located, wherein the first FAU is on the top surface of the second pedestal and the second FAU is on a top surface of the third pedestal.

Example 27 includes the subject matter of any one of Examples 23-26, wherein the pedestal comprises glass or metal.

Example 28 includes the subject matter of any one of Examples 23-27, wherein the first package substrate comprises a cutout region and the first PIC die and second PIC die are located at an edge defining cutout region.

Example 29 includes the subject matter of any one of Examples 23-28, wherein the first PIC die is within a first cavity in a top side of the first package substrate and the second PIC die is within a second cavity in the top side of the first package substrate.

Example 30 includes the subject matter of any one of Examples 23-29, wherein the second package substrate comprises vias connected between electrical connection pads on a top side of the second package substrate and electrical connection pads on a bottom side of the second package substrate.

Example 31 includes the subject matter of any one of Examples 23-30, wherein the second package substrate comprises one or more of redistribution layer traces and fan-out traces.

In the above description, various aspects of the illustrative implementations have been described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials, and configurations have been set forth to provide a thorough understanding of the illustrative implementations. However, it will be apparent to one skilled in the art that the present disclosure may be practiced without all of the specific details. In other instances, well-known features have been omitted or simplified in order not to obscure the illustrative implementations.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The terms “over,” “under,” “between,” “above,” and “on” as used herein may refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening features.

The above description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact. Further, “adjacent” may refer to layers or components that are in physical contact with each other. That is, there is no layer or component between the stated adjacent layers or components. For example, a layer X that is adjacent to a layer Y refers to a layer that is in physical contact with layer Y.

In various embodiments, the phrase “a first feature formed, deposited, or otherwise disposed on a second feature” may mean that the first feature is formed, deposited, or disposed over the second feature, and at least a part of the first feature may be in direct contact (e.g., direct physical and/or electrical contact) or indirect contact (e.g., having one or more other features between the first feature and the second feature) with at least a part of the second feature. Further, “located on” in the context of a first layer or component located on a second layer or component may refer to the first layer or component being directly physically attached to the second part or component (no layers or components between the first and second layers or components) or physically attached to the second layer or component with one or more intervening layers or components.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

1. An integrated circuit package comprising:
a first package substrate;
a photonics integrated circuit (PIC) die coupled to the first package substrate at an edge of the first package substrate;
a second package substrate coupled to a bottom side of the first package substrate; and
a pedestal coupled to a top side of the second package substrate in an area of the second package substrate that extends beyond the edge of the first package substrate at which the PIC die is located.

2. The integrated circuit package of claim 1, wherein the pedestal is a first pedestal, and the integrated circuit package further comprises a second pedestal coupled to the top side of the second package substrate in an area of the second package substrate that extends beyond the edge of the first package substrate at which the PIC die is located.

3. The integrated circuit package of claim 2, wherein the first pedestal and second pedestal comprise different materials.

4. The integrated circuit package of claim 1, wherein the pedestal comprises glass or metal.

5. The integrated circuit package of claim 1, wherein the first package substrate comprises a cutout region and the PIC die is located at an edge defining cutout region.

6. The integrated circuit package of claim 1, wherein the PIC die is within a cavity in a top side of the first package substrate.

7. The integrated circuit package of claim 1, further comprising an electronic integrated circuit (EIC) die coupled to the first package substrate and connected to the PIC die.

8. The integrated circuit package of claim 1, further comprising a processor coupled to the first package substrate and connected to the EIC die.

9. The integrated circuit package of claim 1, wherein the second package substrate comprises vias connected between electrical connection pads on a top side of the second package substrate and electrical connection pads on a bottom side of the second package substrate.

10. The integrated circuit package of claim 1, wherein the second package substrate comprises one or more of redistribution layer traces and fan-out traces.

11. A system comprising:
an integrated circuit package comprising:
a first package substrate;
a photonics integrated circuit (PIC) die coupled to the first package substrate at an edge of the first package substrate;
a second package substrate coupled to a bottom side of the first package substrate; and
a pedestal coupled to a top side of the second package substrate in an area of the second package substrate that extends beyond the edge of the first package substrate at which the PIC die is located; and
optical fiber coupled to the PIC and on a top surface of the pedestal.

12. The system of claim 11, wherein the optical fiber is adhesively coupled to the pedestal.

13. The system of claim 11, wherein the pedestal is a first pedestal, and the system further comprises a second pedestal coupled to the top side of the second package substrate in an area of the second package substrate that extends beyond the edge of the first package substrate at which the PIC die is located, and wherein the optical fiber is further on a top surface of the second pedestal.

14. The system of claim 11, wherein the first package substrate comprises a cutout region and the PIC die is located at an edge defining cutout region.

15. The system of claim 11, wherein the PIC die is within a cavity in a top side of the first package substrate.

16. The system of claim 11, further comprising an electronic integrated circuit (EIC) die coupled to the first package substrate and connected to the PIC die.

17. The system of claim 11, further comprising a circuit board, wherein the second package is coupled to a top side of the circuit board.

18. A system comprising:
a circuit board;
an integrated circuit package coupled to the circuit board, the integrated circuit package comprising:
a first package substrate;
a first photonics integrated circuit (PIC) die coupled to the first package substrate at an edge of the first package substrate;
a first electronic integrated circuit (EIC) die coupled to the first package substrate and connected to the PIC die;
a second PIC die coupled to the first package substrate at the edge of the first package substrate;
a second EIC die coupled to the first package substrate and connected to the PIC die;
a processor coupled to the first EIC die and the second EIC die;
a second package substrate coupled to a top side of the circuit board and to a bottom side of the first package substrate; and
a pedestal coupled to a top side of the second package substrate in an area of the second package substrate that extends beyond the edge of the first package substrate at which the first PIC die and second PIC die are located;
a first fiber array unit (FAU) coupled to the first PIC and on a top surface of the pedestal; and
a second FAU coupled to the second PIC and on the top surface of the pedestal.

19. The system of claim 18, wherein the pedestal is a first pedestal, the system further comprises a second pedestal coupled to the top side of the second package substrate in an area of the second package substrate that extends beyond the edge of the first package substrate at which the first PIC die and second PIC die are located, and wherein one of the first FAU or the second FAU are on a top surface of the second pedestal.

20. The system of claim 19, further comprising a third pedestal coupled to the top side of the second package substrate in an area of the second package substrate that extends beyond the edge of the first package substrate at which the first PIC die and second PIC die are located, wherein the first FAU is on the top surface of the second pedestal and the second FAU is on a top surface of the third pedestal.
